(19) United States
(12) Patent Application Publication
(10) Pub. No.: US 2006/0088760 A1
(43) Pub. Date: Apr. 27, 2006

(54) Metallization of composite plate for fuel cells

(76) Inventor: Hsai-Yin Lee, Troy, MI (US)

Correspondence Address: Kathryn A. Marra - Gerneral Motors Corporation;Legal Staff= Mail Code 482-C23-B21, P.O. Gox 300, Detroit, MI, 48265-3000, US

(21) Appl. No.: 10/973,697

(22) Filed: Oct. 26, 2004

(51) Int. Cl. H01M 2/14

(52) U.S. Cl. 429/129

(57) ABSTRACT

A separator plate for a fuel cell stack includes an electrically non-conductive base plate having a reactant flow field formed in a reactant surface thereof. An electrically conductive layer is bonded to the reactant surface of the base plate.

### FIELD OF THE INVENTION

The present invention relates to fuel cells, and more particularly to separator plates of fuel cell stacks.

### BACKGROUND OF THE INVENTION

Fuel cells produce electricity through electrochemical reaction and have been used as power sources in many applications. Fuel cells can offer significant benefits over other sources of electrical energy, such as improved efficiency, reliability, durability, cost and environmental benefits. Fuel cells may eventually be used in automobiles and trucks. Fuel cells may also power homes and businesses.

There are several different types of fuel cells, each having advantages that may make them particularly suited to given applications. One type is a proton exchange membrane (PEM) fuel cell, which has a membrane sandwiched between an anode and a cathode. To produce electricity through an electrochemical reaction, hydrogen (H₂) is supplied to the anode and air or oxygen (O₂) is supplied to the cathode.

In a first half-cell reaction, dissociation of the hydrogen (H₂) at the anode generates hydrogen protons (H⁺) and electrons (e⁻). Because the membrane is proton conductive, the protons are transported through the membrane. The electrons flow through an electrical load that is connected across the electrodes. In a second half-cell reaction, oxygen (O₂) at the cathode reacts with protons (H⁺) and electrons (e⁻) are taken up to form water (H₂O). Parasitic heat is generated by the reactions and must be regulated to provide efficient operation of the fuel cell stack.

Separator plates distribute anode and cathode reactants and coolant across the fuel cell stack. Adjacently stacked separator plates define a bipolar plate that forms a portion of and separates adjacent fuel cells. The bipolar plate serves several functions for fuel cell stack operation. More specifically, a surface of the bipolar plate distributes the anode reactant for a fuel cell and another surface of the bipolar plate distributes the cathode reactant for an adjacent fuel cell. Further functions of the bipolar plate include separating individual cells in the fuel cell stack, carrying current and water from the individual fuel cells, humidifying the reactants and regulating fuel cell temperature. In order to perform each of these functions, traditional bipolar plates are somewhat complex in design. More specifically, bipolar plates include straight or serpentine flow channels, internal manifolds, internal humidification and internal cooling.

Bipolar plates, however, include other design constraints. For example, the bipolar plates must be low cost, easy to manufacture, chemically compatible to the reactants and reactant products flowing therethrough, corrosion resistant, have high electrical and thermal conductivity, be gas impermeable and have sufficient mechanical strength.

### SUMMARY OF THE INVENTION

Accordingly, the present invention provides a separator plate for a fuel cell stack. The separator plate includes an electrically non-conductive base plate having a reactant flow field formed in a reactant surface thereof. An electrically conductive layer is bonded to the reactant surface of the base plate.

In one feature, the electrically conductive layer is a metal layer. The metal layer comprises at least one of a metal from a group consisting of Cu, Zn, Co and Ni.

In another feature, the electrically conductive layer comprises a base layer and a covering layer. The base layer comprises at least one of a metal from a group consisting of Cu, Zn, Co and Ni. The covering layer comprises at least one of a metal from a group consisting of Au, Pt, Pd, Ag and Ir.

In still another feature, the base plate is comprised of a material from a group consisting of a thermoplastic and a thermoset.

In yet another feature, a coolant flow field formed in the base plate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-section of a portion of an exemplary fuel cell stack;

FIG. 2 is a more detailed cross-section of a portion of a the fuel cell stack illustrating separator plates that form a bipolar plate according to the present invention; and

FIG. 3 is a cross-section of a metallized layer deposited on reactant surface of the separator plates according to the present invention.

### DETAILED DESCRIPTION OF THE PREFERRED EMBODIMENTS

The following description of the preferred embodiments is merely exemplary in nature and is in no way intended to limit the invention, its application, or uses.

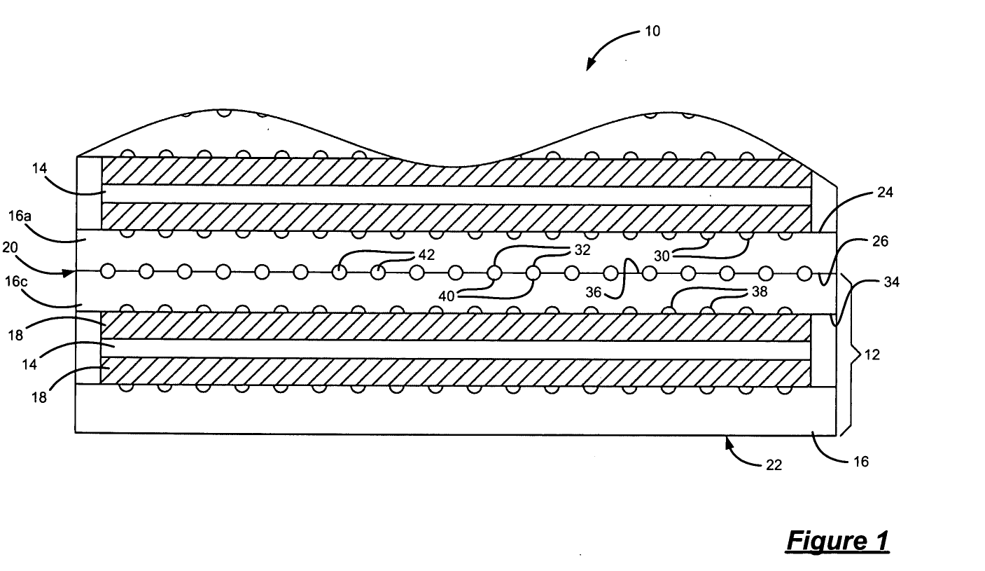

Referring now to FIG. 1, a portion of a fuel cell stack 10 is illustrated. The fuel cell stack 10 includes a series of fuel cells 12. Each fuel cell 12 includes a polymer electrolyte membrane (PEM) 14 sandwiched between separator plates 16. Diffusion media 18 is disposed between the PEM and the separator plates 16. A pair of combined separator plates 16 form a bipolar plate 20 that is disposed between adjacent PEM's 14. A single separator plate 16 defines an end plate 22 disposed on either end of the fuel cell stack 10. An anode reactant (i.e., hydrogen) and a cathode reactant (i.e., oxygen) are distributed by the separator plates 16 for reaction across the PEM 14.

The separator plates 16 of the bipolar plate 20 include an anode plate 16a and a cathode plate 16c. The anode plate 16a has an anode surface 24 and a coolant surface 26. Anode channels 30 are formed in the anode surface 24 and coolant channels 32 formed in the coolant surface 26. The cathode plate 16c includes a cathode surface 34 and a coolant surface 36. Cathode channels 38 are formed in the cathode surface 34 and coolant channels 40 are formed in the coolant surface 36. The anode plate 16a and cathode plate 16c are stacked together so the coolant surfaces 26,36 lie adjacent to one another. The coolant channels 32,40 of the coolant surfaces 26,36 align to form coolant flow paths 42.

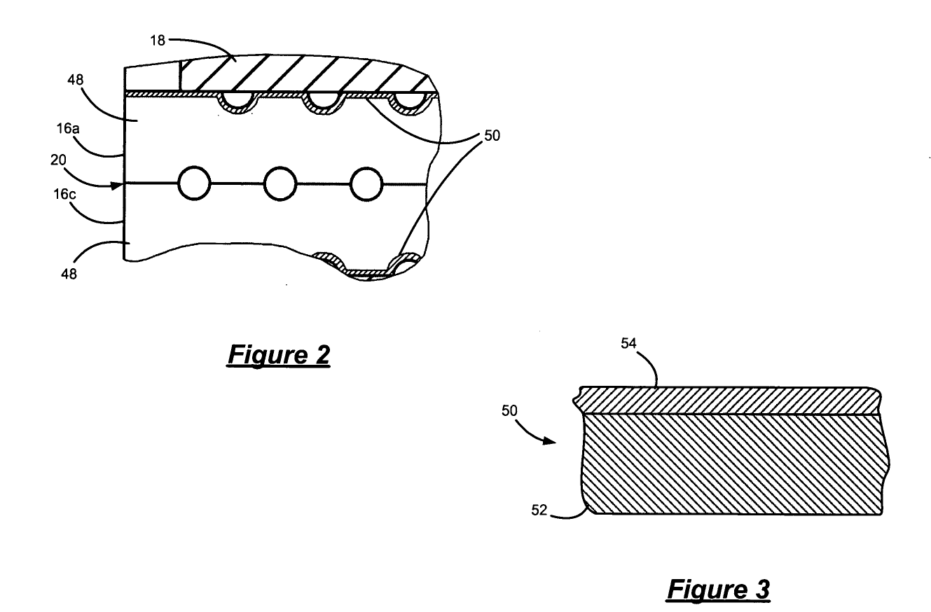

Referring now to FIGS. 2 and 3, formation of the separator plates 16 will be described in detail. The separator plate 16 includes an electrically non-conductive base plate 48 having an electrically conductive layer 50 on the reactant surface 24,34. The electrically conductive layer 50 is in electrical communication with other electrically conductive layers 50 across the fuel cell stack 12. This can be achieved by using end connecters (not shown). In this manner, current generated by the fuel cells 12 can be transferred across the separator plates 16. The base plate 48 is preferably comprised of a composite or plastic material including, but not limited to, a thermoplastic or a thermoset. The electrically conductive layer 50 is preferably corrosion resistant metal layers. Noble metal or alloys thereof, including, but not limited to, palladium and platinum, are preferred for their corrosion resistance properties.

In the case of the base plate 48 being a thermoplastic, a high temperature polymer blend is preferred. One such polymer blend includes NORYL GTX917™, manufactured by GE Plastics. NORYL GTX917™ is a heterogeneous polymer blend that includes nylon 66, polyphenyl oxide (PPO) and a small amount of plastic filler. The thermoplastic is molded into the based plate 48. In this manner, the reactant and coolant channels and other features of the base plate 48 are directly formed by the molding process. After molding, the base plate 48 is degreased and etched to modify the surface in preparation for deposition of the conductive layer 50. Besides etching, other surface modification processes are anticipated, including, but not limited to, sand blasting and UV or laser irradiation. After surface modification, the base plate 48 is neutralized and activated. Activation can be achieved by immersing the base plate 48 in stannous chloride and palladium chloride solutions. The electrically conductive layer 50 is then applied using the plating or metallizing process.

In the case of the base plate 48 being a thermoset, a high temperature, fiber reinforced compression molded sheet molding compound (SMC) is preferred. The thermoset preferably includes in-mold coating (IMC) on the surface with an appropriate amount of finely dispersed calcium carbonate to facilitate the plating or metallizing processes. The thermoset along with the IMC are molded into the based plate 48. As similarly described above for a thermoplastic, the reactant and coolant channels and other features of the base plate 48 are directly formed by the molding process. After molding, the base plate 48 is degreased and etched to modify the surface in preparation for deposition of the conductive layer 50. Besides etching, other surface modification processes are anticipated, including, but not limited to, sand blasting and UV or laser irradiation. After surface modification, the base plate 48 is neutralized and activated. Activation can be achieved by immersing the base plate 48 in stannous chloride and palladium chloride solutions. The electrically conductive layer 50 is then applied using the plating or metallizing process.

The electrically conductive layer 50 is deposited onto the surface of the base plate 48 by a metallizing or electroless plating process. Using electroless plating, metal can be deposited onto non-conductive materials such as composites or plastics. In terms of cost, time and complication, electroless plating is a more efficient process for depositing metal onto non-conductive materials than other processes such as chemical and physical vapor deposition processes. The electroless plating process is independent of any laws of electrical current distribution. As a result, a uniformly thick conductive layer can be deposited onto the entire reactant surface 24,34. Further, the electrically conductive layer 50 can be applied to only a portion of the reactant surface 24,34 if desired. This is achieved by masking the portions of the reactant surface 24,34 and plating the electrically conductive layer 50 on the unmasked portions. Although electroless plating is the preferred deposition process, other processes such as the chemical and vapor deposition processes can be used to deposit the electrically conductive layer 50 onto the base plate 48.

Referring now to FIG. 3, the electrically conductive layer 50 is described in further detail. Although it is anticipated that the electrically conductive layer 50 includes a single layer of material, it is also anticipated that the electrically conductive layer can include multiple layers. For example, the electrically conductive layer 50 can include a base layer 52 and a covering layer 54. The base layer 52 preferably includes a highly conductive material including, but not limited to, copper (Cu), nickel (Ni), cobalt (Co), Zinc (Zn) and alloys thereof. The covering layer 54 preferably includes a conductive, corrosion resistant material including, but not limited to, noble metals. Such noble metals preferably include gold (Au), platinum (Pt), palladium (Pd), silver (Ag), Iridium (Ir) and alloys thereof.

The composite separator plate 16 of the the present invention provides significant advantages over traditional separator plates. The separator 16 is thinner, lighter, cheaper and easier to manufacture than traditional separator plates, including traditional electrically conductive composite separator plates. The electrically conductive layer 50 is highly corrosion resistant and has both high electrical and thermal conductivity, each of which improves the durability of the fuel cell stack 10. Also, because the base plate 48 is electically non-conductive, a less expensive non-dielectric coolant can be implemented to cool the fuel cell stack 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A separator plate for a fuel cell stack, comprising:
an electrically non-conductive base plate having a reactant flow field formed in a reactant surface of said electrically non-conductive base plate; and
an electrically conductive layer bonded to said reactant surface of said base plate.

2. The separator plate of claim 1 wherein said electrically conductive layer is a metal layer.

3. The separator plate of claim 2 wherein said metal layer comprises at least one of a metal from a group consisting of Cu, Zn, Co and Ni.

4. The separator plate of claim 1 wherein said electrically conductive layer comprises a conductive base layer and a conductive covering layer.

5. The separator plate of claim 4 wherein said base layer comprises at least one of a metal from a group consisting of Cu, Zn, Co and Ni.

6. The separator plate of claim 4 wherein said covering layer comprises at least one of a metal from a group consisting of Au, Pt, Pd, Ag and Ir.

7. The separator plate of claim 1 wherein said base plate is comprised of a material from a group consisting of a thermoplastic and a thermoset.

8. The separator plate of claim 1 further comprising a coolant flow field formed in said base plate.

9. A method of manufacturing a separator plate for a fuel cell stack, comprising:
molding an electrically non-conductive base plate to include a reactant surface defining a flow field; and
depositing an electrically conductive layer on said reactant surface of said base plate.

10. The method of claim 9 wherein said step of depositing said electrically conductive layer comprises electroless plating of said electrically conductive layer onto said reactant surface.

11. The method of claim 9 wherein said base plate is molded from one of a group consisting of a thermoplastic and a thermoset.

12. The method of claim 11 further comprising:
degreasing said base plate;
etching said base plate;
neutralizing said base plate; and
activating said base plate.

13. The method of claim 9 wherein said electrically conductive layer comprises a metal layer.

14. The method of claim 13 wherein said metal layer comprises at least one metal from a group consisting of Cu, Zn, Co and Ni.

15. The method of claim 9 wherein said electrically conductive layer comprises a base layer and a covering layer.

16. The method of claim 15 wherein said base layer comprises at least one of a metal from a group consisting of Cu, Zn, Co and Ni.

17. The method of claim 15 wherein said covering layer comprises at least one of a metal from a group consisting of Au, Pt, Pd, Ag and Ir.

18. The method of claim 9 wherein said base plate is molded to define a coolant flow field in a coolant surface.

19. The method of claim 9 further comprising preparing said reactant surface for deposition of said electrically conductive layer.

20. A bipolar plate of a fuel cell stack, comprising:
a first separator plate including an electrically non-conductive base plate having a first reactant surface and a first coolant surface, wherein a first reactant flow field is formed in said first reactant surface of said electrically non-conductive base plate and a first electrically conductive layer is bonded to said first reactant surface of said base plate; and
a second separator plate including an electrically non-conductive base plate having a second reactant surface and a second coolant surface, wherein a second reactant flow field is formed in said second reactant surface of said electrically non-conductive base plate and a second electrically conductive layer is bonded to said second reactant surface of said base plate, wherein said first and second separator plates are bonded together at said first and second coolant surfaces.

21. The bipolar plate of claim 20 wherein said electrically conductive layers each include a metal layer.

22. The bipolar plate of claim 21 wherein said metal layer comprises at least one of a metal from a group consisting of Cu, Zn, Co and Ni.

23. The bipolar plate of claim 20 wherein said electrically conductive layers each comprise a conductive base layer and a conductive covering layer.

24. The bipolar plate of claim 23 wherein said base layer comprises at least one of a metal from a group consisting of Cu, Zn, Co and Ni.

25. The bipolar plate of claim 23 wherein said covering layer comprises at least one of a metal from a group consisting of Au, Pt, Pd, Ag and Ir.

26. The bipolar plate of claim 20 wherein said first and second base plates are comprised of a material from a group consisting of a thermoplastic and a thermoset.

27. The bipolar plate of claim 20 further comprising first and second coolant flow fields respectively formed in said first and second coolant surfaces of said first and second base plates.
